(19) United States
(12) Patent Application Publication
(10) Pub. No.: US 2016/0093229 A1
(43) Pub. Date: Mar. 31, 2016

(54) DISPLAY CONTROL METHOD, DISPLAY CONTROL APPARATUS, AND COMPUTER-READABLE RECORDING MEDIUM

(71) Applicant: FUJITSU LIMITED, Kawasaki-shi (JP)

(72) Inventors: Hidehiko Mayumi, Kawasaki (JP); Toshio Tanaka, Yokohama (JP); Takeaki Kobayashi, Yokohama (JP); Masahiro Kawasaki, Kawasaki (JP)

(21) Appl. No.: 14/860,816

(22) Filed: Sep. 22, 2015

(30) Foreign Application Priority Data
Sep. 30, 2014 (JP) 2014-202521

(51) Int. Cl. G09B 7/02; G06F 3/0482; G06F 3/14; G06F 3/0484

(52) U.S. Cl. CPC G09B 7/02; G06F 3/04842; G06F 3/0482; G06F 3/14

(57) ABSTRACT

A non-transitory computer-readable recoding medium stores a display control program that causes a computer to execute a process. The process includes: receiving specification of a question; referring to scenario data including a scenario in association with each question and selecting one discussion point in accordance with the sequence of the scenario corresponding to the question whose specification has been accepted; and displaying the one discussion point in a mode different from a mode of other discussion points in display of the scenario including the plurality of discussion points and displaying an answer to the one discussion point in a mode different from a mode of other answers in display of a list of answers with respect to the question whose specification has been accepted.

### CROSS-REFERENCE TO RELATED APPLICATION

This application is based upon and claims the benefit of priority of the prior Japanese Patent Application No. 2014-202521, filed on Sep. 30, 2014, the entire contents of which are incorporated herein by reference.

### FIELD

The embodiments discussed herein are related to a display control method, a display control apparatus, and a computer-readable recording medium.

### BACKGROUND

Next-generation type lessons with use of tablet terminals are being conducted. In one example, such next-generation type lessons use digital teaching materials including not only drill materials aiming at memory and/or concentration training, but also the materials for supporting collaborative education, in which a teacher and students as well as students themselves teach and learn from each other. For example, in the field of the above-described collaborative education, a lesson is conducted as follows. That is, a question is transmitted from a teacher terminal to student terminals, opinions as the answers to the question are transmitted from the student terminals to the teacher terminal, the opinions are summarized in the teacher terminal, a list of the opinions of the students are displayed in a matrix form on a screen such as an electronic blackboard, and a discussion about the question is performed.

Patent Document 1: Japanese Laid-open Patent Publication No. 2011-53851

However, in the above-described technology, it is difficult to extract, out of a large number of opinions, an opinion suitable for each scene as the discussion about the question progresses in the lesson. As a result, the progress of the lesson may be delayed.

### SUMMARY

According to an aspect of the embodiments, a non-transitory computer-readable recoding medium stores a display control program that causes a computer to execute a process including: receiving specification of a question; referring to scenario data including a scenario in association with each question, the scenario including a plurality of discussion points concerning the question and a sequence of progressing each of the discussion points in a lesson of the question, and selecting one discussion point, out of the plurality of discussion points, in accordance with the sequence of the scenario corresponding to the question whose specification has been accepted; and displaying, whenever the one discussion point is selected, the one discussion point in a mode different from a mode of other discussion points in display of the scenario including the plurality of discussion points, while referring to answer data including answers to each question in association with the question, and displaying an answer to the one discussion point in a mode different from a mode of other answers in display of a list of answers with respect to the question whose specification has been accepted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates the configuration of a lesson support system according to a first embodiment;

FIG. 2 is a block diagram illustrating a functional configuration of a teacher terminal according to the first embodiment;

FIG. 3 illustrates one example of student data;

FIG. 4 illustrates one example of question data;

FIG. 5 illustrates one example of scenario data;

FIG. 6 illustrates one example of answer data;

FIG. 7 illustrates one example of a question selection screen;

FIG. 8 illustrates one example of an answer screen;

FIG. 9 illustrates one example of an opinion board;

FIG. 10 illustrates one example of the opinion board;

FIG. 11 is a flow chart illustrating procedures of a lesson support process according to the first embodiment;

FIGS. 12A and 12B are a flow chart illustrating procedures of a classification process according to the first embodiment;

FIG. 13 is a flow chart illustrating procedures of a display control process according to the first embodiment;

FIG. 14 illustrates one example of the opinion board; and

FIG. 15 is an explanatory view illustrating one example of a computer that executes a display control program according to the first and second embodiments.

### DESCRIPTION OF EMBODIMENTS

Preferred embodiments will be explained with reference to accompanying drawings. The embodiments are not intended to limit the disclosed technology. Each of the embodiments may properly be combined without causing inconsistency.

### [a] First Embodiment

System Configuration

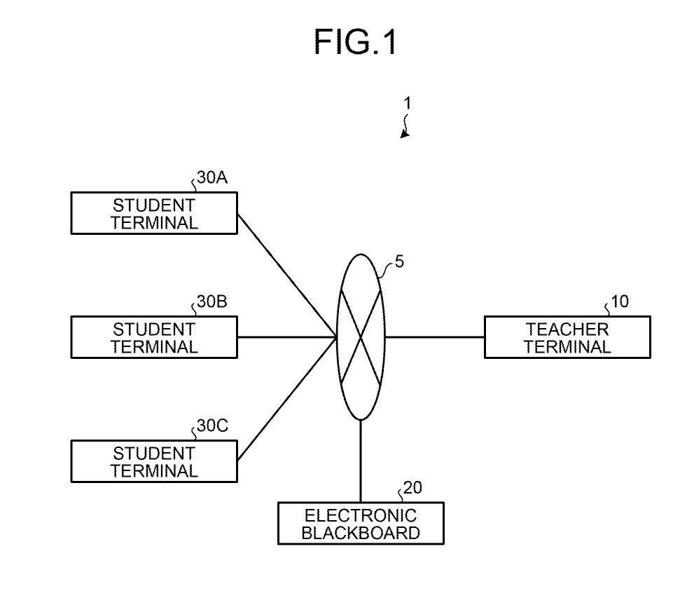

FIG. 1 illustrates the configuration of a lesson support system according to a first embodiment. A lesson support system 1 illustrated in FIG. 1 provides collaborative education support service that supports collaborative education as a form of lesson support through digital teaching materials. In the collaborative education support service, information on students' answers to a certain question displayed as a list (henceforth referred to as an opinion board) is exhibited on an electronic blackboard 20, so that a teacher and students as well as students themselves teach and learn from each other.

As part of this collaborative education support service, a lesson support system 1 highlights a discussion point in progress in display of a scenario whenever the scenario progress, the scenario including a plurality of sequenced discussion points concerning the question. The lesson support system 1 also highlights the answers concerning the discussion point in progress in the display of a list of the answers to the question, so as to support the progress of the lesson.

As illustrated in FIG. 1, the lesson support system 1 incorporates a teacher terminal 10, the electronic blackboard 20, and student terminals 30A to 30C. Although three student terminals are illustrated in FIG. 1, the lesson support system 1 can incorporate any given number of student terminals. In the following, when the student terminals 30A to 30C are collectively referred without distinction between individual terminals, they may be described as “the student terminal 30.”

The teacher terminal 10 and the student terminals 30 are communicably connected with each other through a network 5. As such a network 5, wired or wireless internal networks, such as local area networks (LANs) and virtual private networks (VPNs), may be adopted. In addition, arbitrary types of communication networks, such as the Internet, may also be adopted.

The teacher terminal 10 is a terminal device used by a teacher. The term “teacher” herein refers to the person who teaches among the participants of a lesson. Examples of the teacher may include teachers in various fields, though they may be unauthorized personnel who does not have teacher's licenses of these various fields.

In one embodiment, a collaborative education support program for teacher terminals may be installed on the teacher terminal 10 as generic software or online software for implementing the above-described collaborative education support service. When such a collaborative education support program for teacher terminals is run on the processor of the teacher terminal 10, functions such as selecting a question subjected to collaborative education, transmitting the question to each of the student terminals 30, and displaying a list of opinions returned from the student terminals 30, may be implemented in one example.

For example, a tablet type information processing terminal, so-called a tablet terminal, may be adopted as the teacher terminal 10. Thus, adopting the tablet terminal as the teacher terminal 10 enables the teacher terminal 10 to accept various kinds of instructing operations through touch pens and/or fingers. In addition, the teacher terminal 10 can accept a handwritten input, such as character strings and marks, on a later-described touch panel 11. Hereinbelow, an input of handwritten character strings and marks, which are input onto a touch panel with touch pens and/or fingers, may be referred to as “handwriting input,” whereas character strings and marks that the touch panel accepts through handwriting input may be referred to as “mark description.”

The electronic blackboard 20 displays an image output from a specified projector and the like.

In one embodiment, an interactive white board may be adopted as the electronic blackboard 20. The electronic blackboard 20 is connected to a projector, which is not illustrated. With this projector, a picture specified to be displayed by the teacher terminal 10 is projected on the electronic blackboard 20. This electronic blackboard 20 can display an image same as or different from the image displayed on the teacher terminal 10. It is naturally understood that the above-described electronic blackboard 20 may be any one of unit-type, board-type, and integral-type electronic blackboards.

The student terminals 30 are terminal devices used by students. The term “students” herein refer to persons who are taught among the participants of the lesson. Examples of the students may include educatees of various kinds, but they may also be other than the educatees.

In one embodiment, a collaborative education support program for student terminals is installed on the student terminals 30. When such a collaborative education support program for student terminals is run on the processor of the student terminals 30, functions such as receiving a question from the teacher terminal 10, inputting opinions with respect to the question, and transmitting answers to the teacher terminal 10, can be implemented in one example.

For example, a tablet terminal can be adopted as the student terminal 30 as with the case of the above-described teacher terminal 10. By adopting this tablet terminal, the student terminals 30 can accept various kinds of instructing operations for the collaborative education support program through touch pens and/or fingers.

In this embodiment, between the teacher terminal 10 and the student terminals 30, the teacher terminal 10 is made to function as a server apparatus while the student terminals 30 are made to function as a client terminal. However, the physical configuration of the lesson support system 1 is not limited thereto. For example, a client/server system may be constructed wherein a server apparatus may be placed independently of the teacher terminal 10, and both the teacher terminal 10 and the student terminals 30 are incorporated as client terminals.

Although the teacher terminal 10 and the student terminals 30 are implemented as tablet terminals in this embodiment, the mode of implementing the teacher terminal 10 and/or the student terminals 30 is not limited thereto. For example, the teacher terminal 10 and the student terminals 30 may be implemented as mobile terminal apparatuses including mobile communication terminals, such as smartphones, portable telephones, and personal handyphone systems (PHSs). The teacher terminal 10 and the student terminals 30 may also be implemented as a stationary information processing apparatus such as personal computers, or be implemented as a notebook personal computer.

Configuration of Teacher Terminal 10

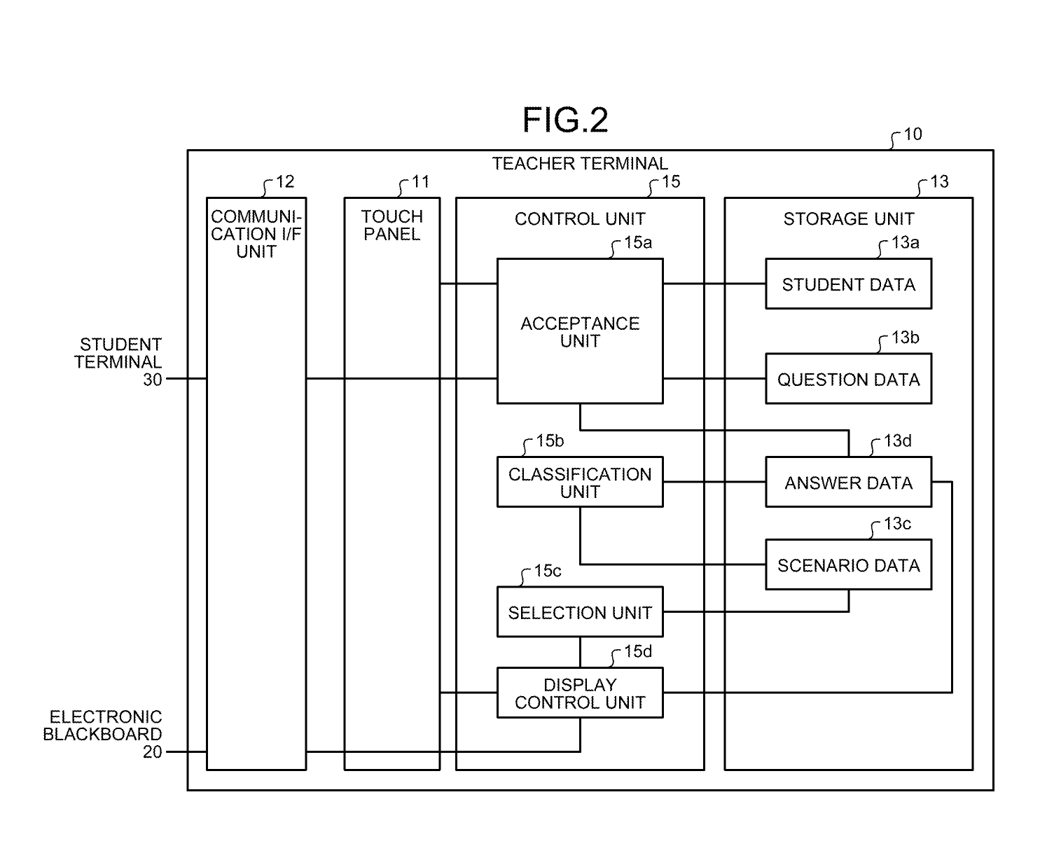

A description will now be given of the functional configuration of the teacher terminal 10 according to this embodiment. FIG. 2 is a block diagram illustrating the functional configuration of the teacher terminal 10 according to the first embodiment. As illustrated in FIG. 2, the teacher terminal 10 has a touch panel 11, a communication interface (I/F) unit 12, a storage unit 13, and a control unit 15.

In addition to the function units illustrated in FIG. 2, the teacher terminal 10 may have various kinds of function units included in known computers. For example, when the teacher terminal 10 is implemented as a tablet terminal, the teacher terminal 10 may further have a motion sensor, such as an acceleration sensor and an angular velocity sensor. When the teacher terminal 10 is implemented as a mobile communication terminal, the teacher terminal 10 may further have function units, such as an antenna and a global positioning system (GPS) receiver. FIG. 2 illustrates the function units when the teacher terminal 10 is implemented as a tablet terminal. However, when the teacher terminal 10 is implemented as a stationary terminal, the teacher terminal 10 may have I/O devices, such as a keyboard, a mouse, and a display.

The touch panel 11 illustrated in FIG. 2 is a device enabling display and input operations. As one aspect of the display operation, the touch panel 11 displays images output by the collaborative education support program executed on the teacher terminal 10, as well as images output by an OS (Operating System) and/or application programs. As one aspect of the input operation, the touch panel 11 accepts handwritten input with touch pens, fingers, and the like, as well as touch operation, such as tap, flick, swipe, pinch-in, and pinch-out performed on the screen of the touch panel 11. The touch panel 11 is illustrated as an input device that inputs commands for the teacher terminal 10. However, without being limited thereto, an input device such as a physical key, which implements a complementary input with the touch panel 11 may further be provided.

The communication I/F unit 12 is an interface that controls communication with other apparatuses, such as the electronic blackboard 20, and the student terminals 30.

In one embodiment, a network interface card such as a LAN card may be adopted as the communication I/F unit 12. For example, the communication I/F unit 12 distributes a question subjected to the collaborative education to the student terminals 30, and receives from the student terminals 30 the answers to the question in the form of opinions. The communication I/F unit 12 transmits to the electronic blackboard 20 an image, such as an opinion board, to be displayed on the electronic blackboard 20, and accepts from the electronic blackboard 20 operations which have been accepted on the electronic blackboard 20.

The storage unit 13 is a storage device that stores an OS executed by the control unit 15 as well as the data used for various programs, such as the above-described collaborative education support program.

In one embodiment, the storage unit 13 is implemented as a main storage in the teacher terminal 10. For example, various kinds of semiconductor memory devices such as random access memories (RAMs) and flash memories may be adopted as the storage unit 13. The storage unit 13 may also be implemented as an auxiliary storage. In that case, hard disk drives (HDDs), optical discs, solid-state drives (SSDs), and the like may be adopted.

The storage unit 13 stores student data 13a, question data 13b, scenario data 13c, and answer data 13d as one example of the data used for the programs executed by the control unit 15. The storage unit 13 may also store other electronic data, such as drill materials for memory and/or concentration training, in addition to the above-described data.

The student data 13a is data about students.

In one embodiment, data including items, such as a student identifier (ID), a student name, and a student terminal IP address, in association with each other, may be adopted as the student data 13a. The item “student ID” may herein refer to the identification information for identifying each student who participates in a lesson. In one aspect, the term may also refer to the identification information of the student terminal 30 used by each student. The item “student name” refers to the family name of the student. The item “student terminal IP address” refers to the IP address of each student terminal 30.

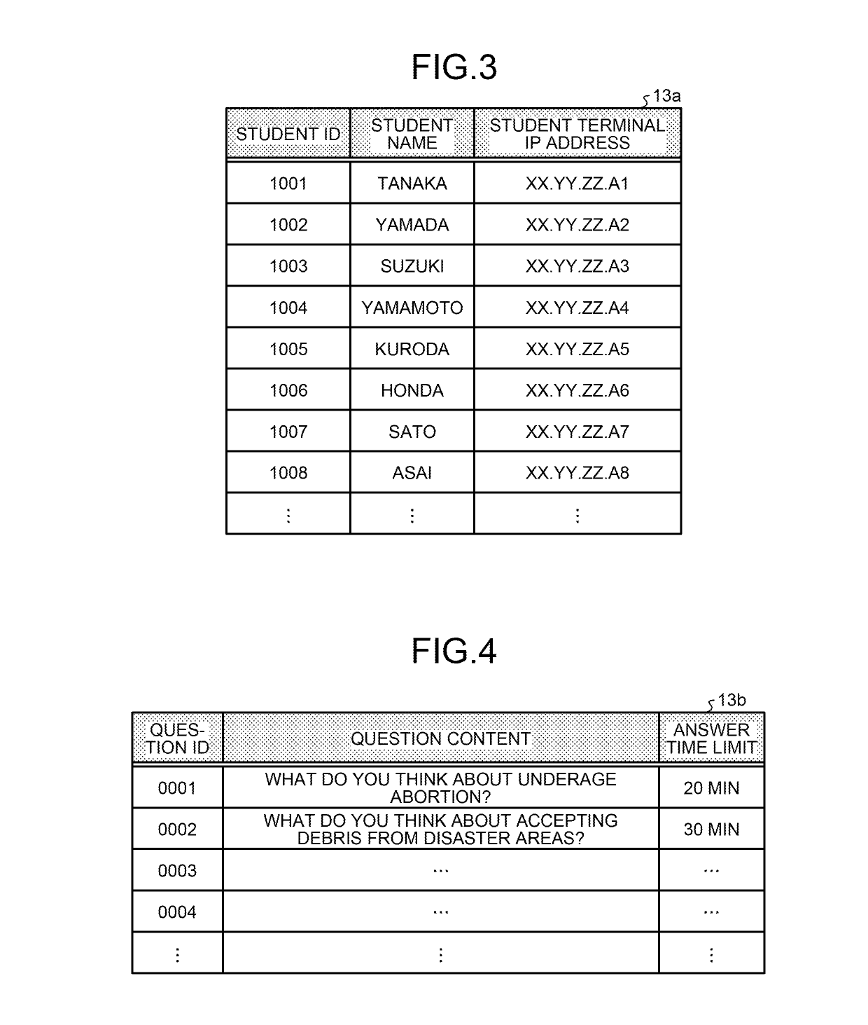

FIG. 3 illustrates one example of the student data 13a. FIG. 3 illustrates student IDs, student names, and student terminal IP addresses of eight students. For example, a first record illustrated in FIG. 3 indicates that the student name identified by the student ID “1001” is “Tanaka,” and the IP address of the student terminal used by Tanaka is “XX.YY.ZZ.A1.” The second and following records indicate the same information though the items therein take different values. Although entries of eight students are illustrated in FIG. 3, any number of entries may be possible. When students are divided into classes, the student IDs, the student names, and the student terminal IP addresses may also be managed per class.

The question data 13b is data about questions.

In one embodiment, as the question data 13b, data including items, such as a question ID, a question content, and an answer time limit, in association with each other, may be adopted. The item “question ID” herein refers to the identification information for identifying each question given to the students in the lesson of collaborative education and the like. The item “question content” refers to the content of the question, such as the subject of a discussion performed between the teacher and the students and between students themselves. The item “answer time limit” refers to an imposed time limit when the students answer the question. The above-described question data 13b may be stored in advance as supporting materials, or the teacher may input and register the question through the teacher terminal 10.

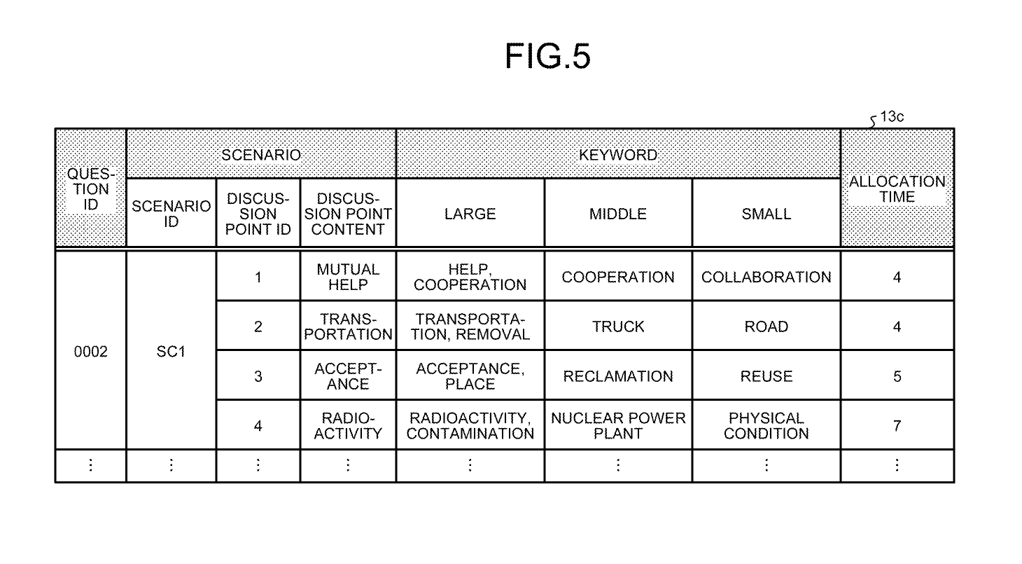

FIG. 4 illustrates one example of the question data 13b. In the example of the first record illustrated in FIG. 4, it is indicated that the content of the question identified by the question ID “0001” is “what do you think about underage abortion?”, and the time to answer the question in the form of opinion and the like is 20 minutes or less. In the example of the second record illustrated in FIG. 4, it is indicated that the content of the question identified by the question ID “0002” is “What do you think about accepting debris from disaster areas?”, and the time to answer the question in the form of opinion and the like is 30 minutes or less. The third and following records indicate the same information though the items therein take different values.

The scenario data 13c are data about scenario. The term “scenario” herein refers to an order of expanding logic, thought, and/or judgment. For example, the scenario includes a plurality of discussion points concerning a question, and a progress sequence along which the discussion concerning each discussion point is progressed in the lesson concerning the question.

In one embodiment, as the scenario data 13c, data including items, such as a question ID, a discussion point ID, a discussion point content, a keyword, and allocation time, in association with each other, may be adopted. The item “scenario ID” herein refers to the identification information for identifying the above-described scenarios. The item “discussion point ID” refers to the identification information for identifying the above-described discussion points. For example, the discussion points included in a scenario are numbered in an ascending order based on the progress sequence. When the discussion point IDs are numbered in this manner, a characteristic value is allocated to each of the discussion points, and these values allocated to the respective discussion points represent a progress sequence. Accordingly, the discussion point IDs are used as the identification information of the discussion points, and are also usable as the identification information of the progress sequence. The item “discussion point content” refers to the content of the above-described discussion points.

The item “keyword” refers to a word used for classifying the answers with respect to a question. For example, the words relating to the discussion points included in the scenario corresponding to the question are set as keywords. In one example, when such keywords match with character strings contained in one answer, the keywords are categorized into three categories of “large,” “middle,” and “small,” in accordance with the amount of points allocated to the answer. These categories have a higher correlation with the discussion points in the order of the category “large,” the category “middle,” and the category “small.” Here, in one example, when a character string in the answer matches with a keyword in the category “large,” three points are assumed to be allocated to the answer. When a character string in the answer matches with a keyword in the category “middle,” two points are assumed to be allocated to the answer. When a character string in the answer matches with a keyword in the category “small,” one point is assumed to be allocated to the answer. The item “allocation time” refers to the time allocated to each discussion point, the time being allocated from the total time given to one question to be discussed in the lesson of collaborative education. Hereinbelow, in the case of a keyword search in the answer, a character string matched with a keyword is searched. However, a similarity search may be performed so that related terms and class words are included in the search result.

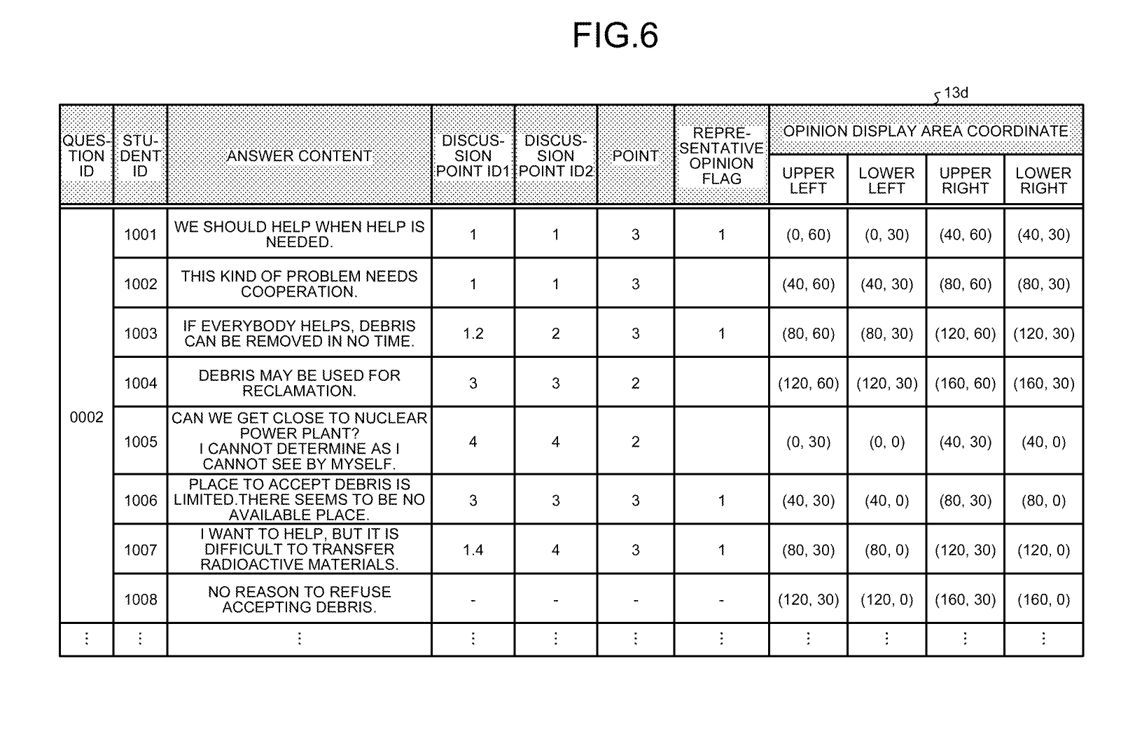

FIG. 5 illustrates one example of the scenario data 13c. FIG. 5 illustrates a scenario concerning the question “what do you think about accepting debris from disaster areas?” which is identified by the question ID “0002” illustrated in FIG. 4. In the example of the scenario ID “SC1” illustrated in FIG. 5, the scenario includes four discussion points of “mutual help,” “transportation,” “acceptance,” and “radioactivity,” and the discussion progresses in the sequence of “mutual help,” “transportation,” “acceptance,” and “radioactivity.” Furthermore, in the example of the discussion point “mutual help” included in the scenario ID “SC1,” the answer including a keyword “help” or “cooperation” receives three points, the answer including the keyword “cooperation” receives two points, and the answer including the keyword “collaboration” receives one point. This rule also applies to the keywords concerning other discussion points, though the values of the point to be allocated may be different. Furthermore, out of total twenty-minutes time given to the discussion about one question in the lesson of collaborative education, four minutes are allocated to the discussion concerning the discussion point “mutual help,” four minutes are also allocated to the discussion concerning the discussion point “transportation,” five minutes are allocated to the discussion concerning the discussion point “acceptance,” and seven minutes are allocated to the discussion concerning the discussion point “radioactivity.”

The answer data 13d is data about answers to each question.

In one embodiment, as the answer data 13d, data include items, such as a question ID, a student ID, an answer content, a discussion point ID1, a discussion point ID2, a point, a representative opinion flag, and opinion display area coordinates, in association with each other, may be adopted.

The item “answer content” herein refers to the content of argument and/or idea of each student with respect to a certain question. For example, the content includes a reason of pros and cons, and an approach to the question. The item “discussion point ID1” refers to a discussion point ID of a discussion point into which a character string of the answer is classified. For example, on condition that the character string matched with a keyword is included in the answer, the discussion point ID associated with the keyword is registered in the discussion point ID1. For each of the keywords matched with the character strings in the answer, pertinent discussion point IDs are registered in the discussion point ID1. Accordingly, when the answer includes a keyword which is associated with a plurality of discussion points, a plurality of discussion point IDs may be registered in the same discussion point ID1. The item “discussion point ID2” refers to a discussion point ID of a discussion point into which a character string of the answer is classified. For example, one discussion point ID is selected from the discussion point IDs in the discussion point ID1. As described later in detail, the scenario progresses as the discussion points included in the scenario are selected based on the progress sequence. When the scenario progresses to a discussion point in the discussion point ID2, the answer corresponding to the discussion point is highlighted among the answers displayed on the opinion board as a list. The item “point” refers to a score indicative of the level of correlation between the character string of the answer and the discussion point in the discussion point ID2. For example, the point can be calculated by summing up the number of keywords hit by the search for the character strings of the answer. The item “representative opinion flag” refers to a flag imparted to the answer (opinion) which represents the answers identical in the value of the discussion point ID2.

The item “opinion display area coordinates” refers to the coordinates of an area where an opinion returned from each student terminal 30 is displayed on the opinion board. For example, when the opinion of a student is displayed in a rectangular area, the opinion display area is expressed by the coordinates of four peaks “upper left,” “lower left,” “upper right,” and “lower right” of the area. In the following, the area that displays one opinion in the opinion board may be referred to as “opinion display area.” Although the opinion display area is defined by four peaks in this example, the opinion display area may be defined by other arbitrary methods. For example, the opinion display area may also be defined by one peak or a barycenter and the height and width of the area, or the like.

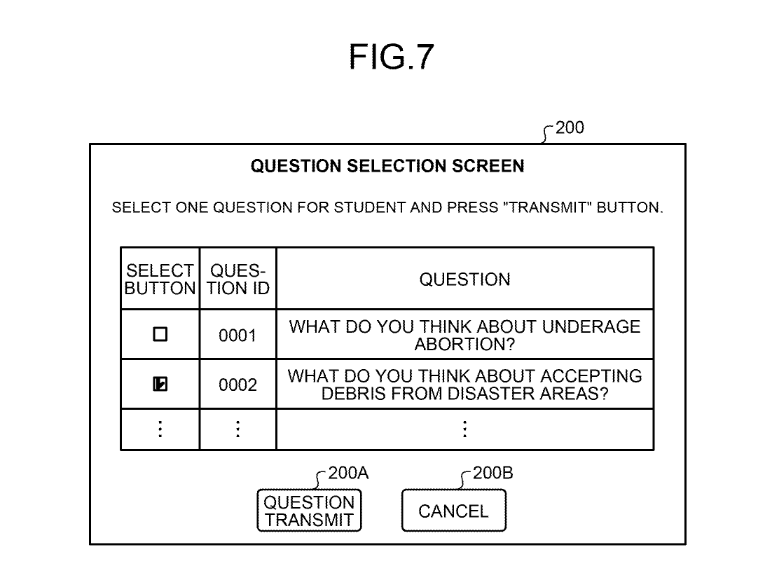

FIG. 6 illustrates one example of the answer data 13d. FIG. 6 illustrates the contents of answers to the question identified by the question ID “0002” illustrated in FIG. 4, the answers being given by eight students illustrated in FIG. 3. FIG. 6 illustrates the case of adopting a coordinate system having an origin set at the lower left peak of the opinion board, as one example of the coordinate system. In the example illustrated in FIG. 6, the opinion board is equally divided into eight areas with two areas in a perpendicular direction and four areas in a cross direction. As a result, one area made of thirty dots in height and forty dots in width is displayed on the opinion board. This means that each opinion is displayed from the left-hand side of the opinion board in the order of the areas of Tanaka, Yamada, Suzuki, and Yamamoto. Furthermore, the opinion of Kuroda is displayed under the opinion of Tanaka, the opinion of Honda is displayed under the opinion of Yamada, the opinion of Sato is displayed under the opinion of Suzuki, and the opinion of Asai is displayed under the opinion of Yamamoto.

For example, in the example of the record of the student ID “1003” illustrated in FIG. 6, the answer of Suzuki includes two discussion points of “mutual help” and “transportation” based on the information in the discussion point ID1. Based on the information in the discussion point ID2, the answer is classified into the discussion point “transportation” out of these two discussion points. This means that the answer of Suzuki is highlighted when the scenario reaches the discussion point “transportation.” Furthermore, the answer of Suzuki has a representative flag opinion of 1. This means that the answer of Suzuki is used as a representative of the discussion point “transportation” when the scenario reaches the discussion point “transportation.” Other records indicate the same information though their items take different values. In view of the entire answer data 13d illustrated in FIG. 6, it becomes possible to make a computer recognize that not only the answer of Suzuki with the student ID “1003” but also the answer of Sato with the student ID “1007” can be classified into a plurality of discussion points including “mutual help” and “radioactivity.” Furthermore, it becomes possible to make the computer recognize that not only the answer of Suzuki with the student ID “1003,” but also the answer of Tanaka with the student ID “1001,” the answer of Honda with the student ID “1006,” and the answer of Sato with the student ID “1007” are used as representative opinions, when the scenario progresses to each of the discussion points.

Here, it is assumed that the opinion display area of each student on the opinion board is determined in advance, i.e., the items other than the opinion content are initially set before the answers are obtained. In this case, it is possible to dynamically change whose opinion is placed in which display area. For example, assume the case of further accepting the pros and cons of the question as an answer. In this case, the opinions may be sorted and displayed in accordance with the pros and cons of the question, may be sorted and displayed in the order of acceptance of the answers, or may be sorted and displayed in the order specified by the teacher terminal 10.

Although FIGS. 3 to 6 illustrate the case where data is stored in a table format, the data may be stored in other formats, such as an object description and an extensible markup language (XML).

The control unit 15 has an internal memory that stores various kinds of programs and control data, and executes various processes therewith.

In one embodiment, the control unit 15 is implemented as a central processing unit called CPU. The control unit 15 may be implemented not as a central processing unit, but as a micro processing unit (MPU). The control unit 15 may also be implemented as a hard-wired logic, such as an application specific integrated circuit (ASIC) and a field programmable gate array (FPGA).

The control unit 15 executes various kinds of programs to virtually implement the following processing units. For example, the control unit 15 has an acceptance unit 15a, a classification unit 15b, a selection unit 15c, and a display control unit 15d as illustrated in FIG. 2.

The acceptance unit 15a is a processing unit that accepts specification of the questions.

In one embodiment, the acceptance unit 15a enables the teacher terminal 10 to specify a question distributed to the student terminal 30. For example, the acceptance unit 15a starts the process, when the item of question selection is selected from the menu screen displayed on the touch panel 11. More specifically, the acceptance unit 15a displays on the touch panel 11 a question selection screen including question IDs to be selected and a question transmit button to request distribution of the question. In this example, the question is specified by operating the touch panel 11. However, it is also possible to store certain time in association with a question as a time schedule. As a result, on condition that the time included in the time schedule has come, the question corresponding to the time may automatically be specified.

When a question ID is selected in the question selection screen and then the question transmit button is pressed, the acceptance unit 15a creates an answer screen including a question content, out of the question contents included in the question data 13b, which corresponds to the question ID whose selection has been accepted in the question selection screen. Next, the acceptance unit 15a transmits the answer screen previously generated to the student terminals 30. For example, the acceptance unit 15a can create answer screen data including an input form in which an answer to the question is input in the form of opinion and the like, and can transmit the answer screen data to the student terminals 30 together with the question content to be displayed. Although the teacher terminal 10 creates the answer screen in this example, the acceptance unit 15a may transmit a question ID or a question corresponding to the question ID, and the collaborative education support program for student terminals to be executed on the student terminals 30 may create an answer screen by using the question ID or the question.

For example, the answer screen may include GUI components, such as a text box for inputting text data. This enables the opinions concerning the question to be accepted through the GUI, such as a software keyboard. Furthermore, the answer screen may include a button for commanding transmission of the answer to the teacher terminal 10. This enables the students to indicate their intention to transmit their opinions concerning the question, which is input through the GUI such as a text box, to the teacher terminal 10.

After transmission of the answer screen, the acceptance unit 15a acquires an answer time limit, out of the answer time limits included in the question data 13b, which is associated with the question ID whose selection has been accepted through the question selection screen. Then, the acceptance unit 15a accepts the answers transmitted from the student terminals 30, i.e., character strings of the answers input in the answer screen. In this case, the character strings of the answers are registered in the records of the student IDs corresponding to the IP addresses of the student terminals 30, among the records included in the answer data 13d. Then, the acceptance unit 15a waits for transmission of the answers from the student terminals 30 to the teacher terminal 10 until all the answers from the student terminals 30 are accepted or until the answer time limit expires. Whenever one of the answers is received, the process of registering the received answer in the answer data 13d is repeatedly executed.

The classification unit 15b is a processing unit that classifies the answers to each question.

In one embodiment, when the answers from all the student terminals 30 are accepted, or the answer time limit expires, the classification unit 15b reads answers corresponding to the question ID of the question transmitted to the student terminals 30, out of the answers in the answer data 13d stored in the storage unit 13. The classification unit 15b then selects one of the answers previously read. In this state, the classification unit 15b searches for the character strings included in the answer previously selected, by using the keywords associated with the question ID of the question transmitted to the student terminals 30, among the keywords included in the scenario data 13c. In this case, when one of the keywords is hit as a result of searching, the classification unit 15b registers one or more discussion point IDs associated with the hit keyword in the field of the discussion point ID1 of a record including an entry of the previously selected answer, among the records in the answer data 13d.

Here, when the hit keyword relates to a plurality of discussion points (when a plurality of discussion point IDs are included in the field of the discussion point ID1), the classification unit 15b registers the discussion point ID, whose ID value is largest among the discussion point IDs associated with each hit keyword, in the field of the discussion point ID2 of the record including an entry of the previously selected answer, among the records in the answer data 13d. Contrary to this, when the hit keyword does not relate to a plurality of discussion points, the classification unit 15b registers the discussion point ID associated with the hit keyword in the field of the discussion point ID2 including an entry of the previously selected answer, among the answers of the answer data 13d. Then, the classification unit 15b repeatedly executes the process including keyword search and registration of the discussion point IDs in the field of the discussion point ID1 and the discussion point ID2, for all the answers in the answer data 13d read from the storage unit 13. Although the above-described process is executed one record at a time in the above example, all the answers may be processed in parallel.

Thus, the classification unit 15b registers the discussion point ID associated with the hit keyword in the field of the discussion point ID2 included in the answer data 13d. As a consequence, the answer is classified into at least one of the discussion points included in the scenario corresponding to the question.

Then, the classification unit 15b determines whether or not the discussion point IDs concerning all the discussion points are present in the entries of the discussion point ID2 in the records corresponding to the question ID transmitted to the student terminals 30, among the records in the answer data 13d. When the discussion point IDs concerning all the discussion points are not present, the classification unit 15b further determines whether or not any record includes the absent discussion point ID as an entry of the discussion point ID1. When a record includes the discussion point ID of the missing discussion point as an entry of the discussion point ID1, the classification unit 15b replaces an entry in the field of the discussion point ID2 of that record, with the missing discussion point ID. Accordingly, when the answers collected from the student terminals 30 are unevenly classified, the answers that can be reclassified into a plurality of discussion points can be reclassified into the discussion point, which is in short of the answer classified thereto. As a result, uneven classification of the answers can be smoothed.

Then, for each of the records corresponding to the question ID transmitted to the student terminals 30, among the records in the answer data 13d, the classification unit 15b sums up the points of the keywords included in the character strings of the answer, among the keywords associated with the entries of the discussion point ID2, to calculate the similarity between the answer and the discussion point. The calculated result of the points calculated here is registered as an entry of the point in each record of the answer data 13d. In this state, the classification unit 15b asserts the representative opinion flag of the answer whose point is largest among the answers having an identical discussion point ID in the discussion point ID2, that is, the classification unit 15b sets the representative opinion flag of the answer to “1,” for example. When a plurality of answers have the same number of points, the answer whose representative opinion flag is asserted may be determined at random, or the answer having a smaller number of entries in the discussion point ID1 may preferentially be selected.

The selection unit 15c is a processing unit that refers to the scenario data 13c and selects one discussion point out of a plurality of discussion points in accordance with the sequence of the scenario corresponding to the question.

In one embodiment, after the classification unit 15b finished classification of the answers, the selection unit 15c reads the scenario corresponding to the question ID transmitted to the student terminals 30, out of the scenarios in the scenario data 13c stored in the storage unit 13, i.e., the selection unit 15c reads a series of discussion point IDs constituting the progress sequence. The selection unit 15c also reads the allocation time of each discussion point, and the like. In this state, the selection unit 15c selects a first discussion point ID, i.e., the discussion point top in the progress sequence, among a series of discussion point IDs included in the previously read scenario. Then, the selection unit 15c monitors the allocation time corresponding to the previously selected discussion point ID. Once the allocation time expires, the selection unit 15c determines whether or not a series of discussion point IDs include a discussion point ID subsequent to the currently selected discussion point ID. In this case, when the subsequent discussion point ID is present, the selection unit 15c selects the subsequence discussion point ID, and continues to monitor the allocation time. Thus, the selection unit 15c repeats the process of selecting a series of discussion point IDs included in the scenario in accordance with the progress sequence so as to progress the scenario.

In this example, discussion point selection is executed with a lapse of the allocation time as a condition. However, in the case where specification of one discussion point out of a series of discussion points is accepted through the touch panel 11 and the like, the discussion point whose specification has been accepted may be selected.

The display control unit 15d is a processing unit that executes display control of the touch panel 11 and/or the electronic blackboard 20.

In one embodiment, when the answers from all the student terminals 30 are accepted, or the answer time limit expires, the display control unit 15d reads the answers corresponding to the question ID transmitted to the student terminals 30, out of the answers in the answer data 13d stored in the storage unit 13. Then, the display control unit 15d executes the following process, whenever a discussion point ID is selected by the selection unit 15c, i.e., whenever the scenario progresses. More specifically, the display control unit 15d sets an answer, among the previously read answers, to be displayed in white, the answer having a discussion point ID selected by the selection unit 15c as an entry of the discussion point ID2. The display control unit 15d also sets an answer to be displayed in gray, the answer not having the discussion point ID selected by the selection unit 15c as an entry of the discussion point ID2. Furthermore, the display control unit 15d sets a discussion point, among a series of discussion points constituting the progress sequence, to be displayed in white, the discussion point being currently selected by the selection unit 15c. The display control unit 15d also sets other discussion points to be displayed in gray.

In this state, the display control unit 15d places the opinion display areas of each answer in a matrix form based on opinion display area coordinates. The display control unit 15d also displays on the electronic blackboard 20 a list of the answers with use of the opinion board by painting out the opinion display area of each answer in accordance with the previously set display colors. The display control unit 15d further displays on the touch panel 11 a scenario indication formed by painting out a series of discussion points that constitute the progress sequence, in accordance with the previously set display colors, the scenario indication being included in the previously-described opinion board. In the following, the opinion board including the scenario indication displayed on the touch panel 11 may be referred to as “opinion board with scenario indication.” In this example, highlighting is implemented by using a contrast between the paint-out display colors. However, highlighting used by the display control unit 15d is not limited to the method disclosed. Arbitrary highlighting may be performed as long as display objects are different in a display mode from each other. For example, highlighting may be performed by changing the luminance or hue of the painted-out or shaded opinion display area. Highlighting may also be performed by changing the shape or the size of a display frame, or by changing character fonts.

Thus, when the opinion board with scenario indication is displayed on the touch panel 11, the display control unit 15d can also highlight the answer whose representative opinion flag is asserted, among the answers classified into a subsequent discussion point immediately after the discussion point currently selected by the selection unit 15c in the progress sequence. The display control unit 15d can also impart a representative opinion mark to the answer.

In this example, the content of the screen displayed on the touch panel 11 may be different from the content of the screen displayed on the electronic blackboard 20 according to the circumstances. However, the screen of the same content may be displayed on both the display devices.

Specific Examples of Record Control

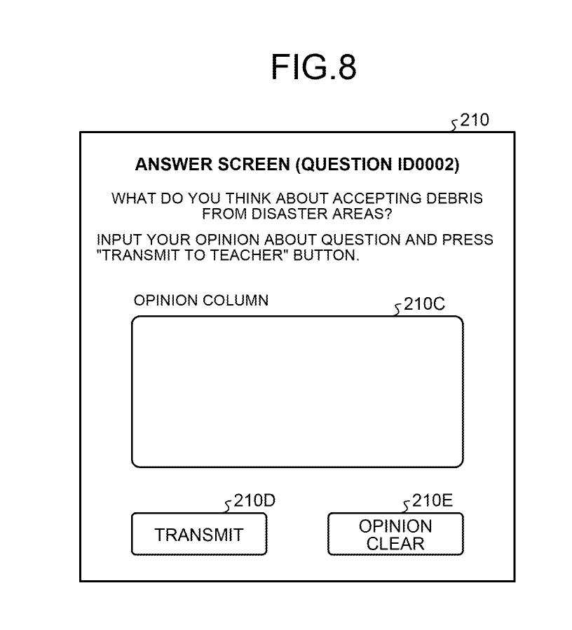

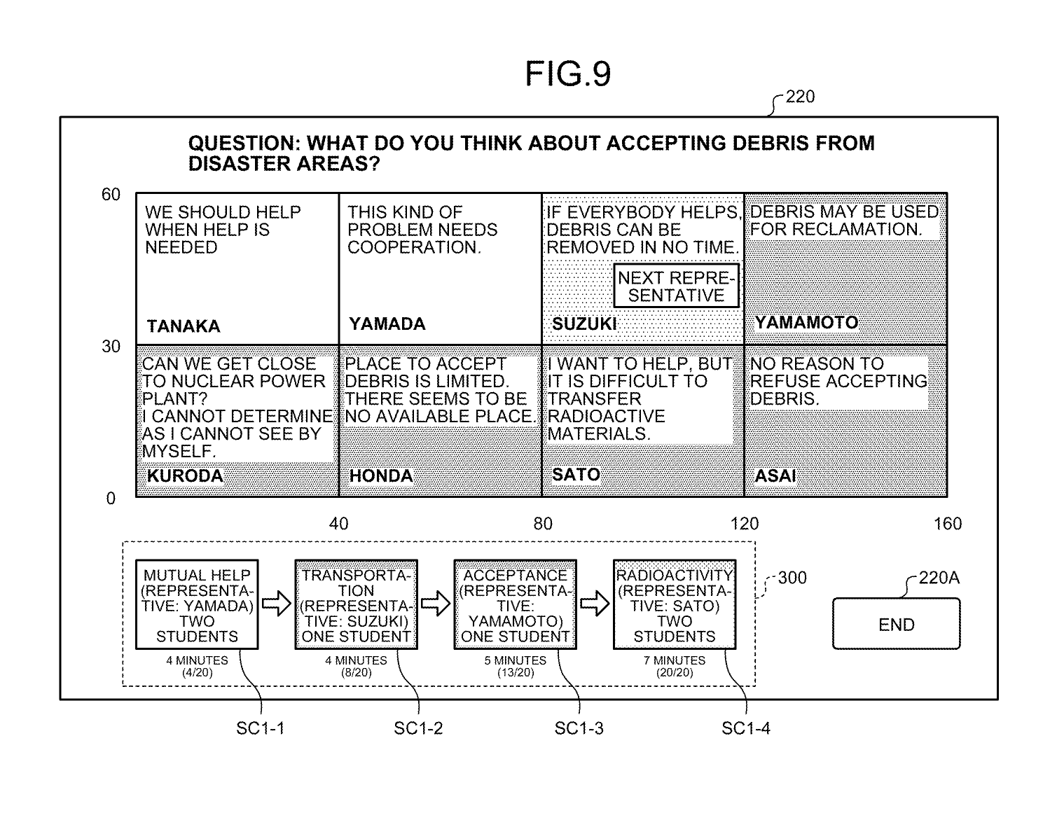

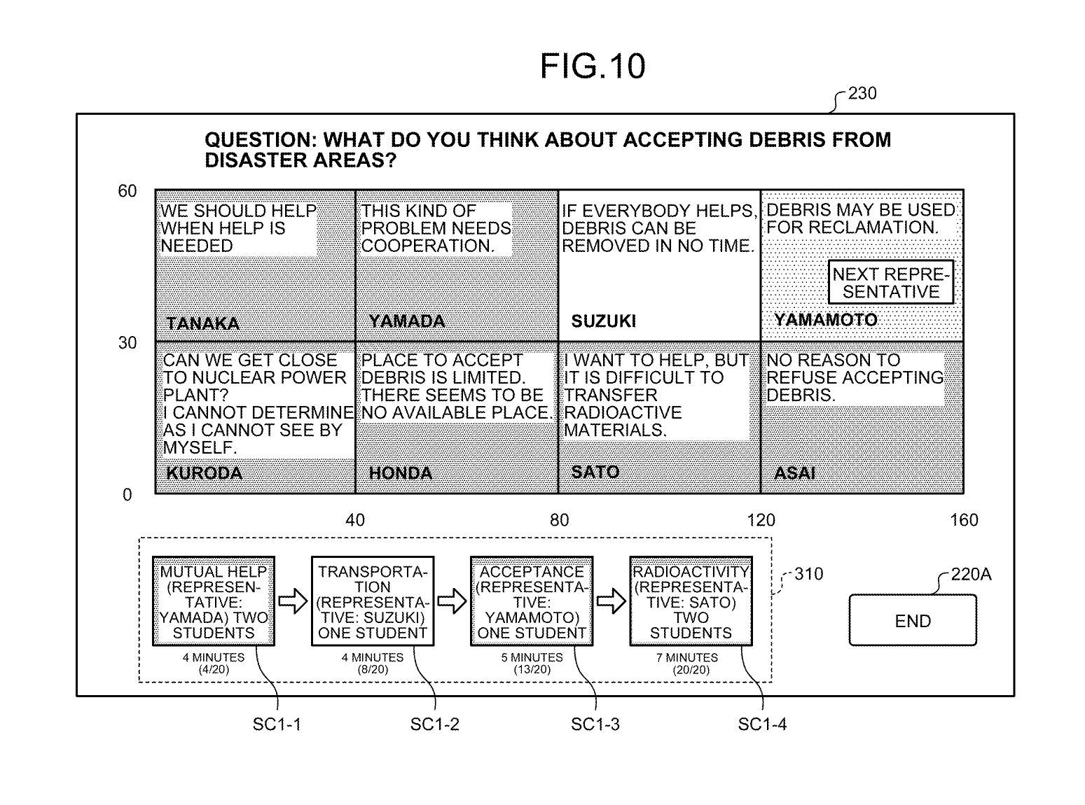

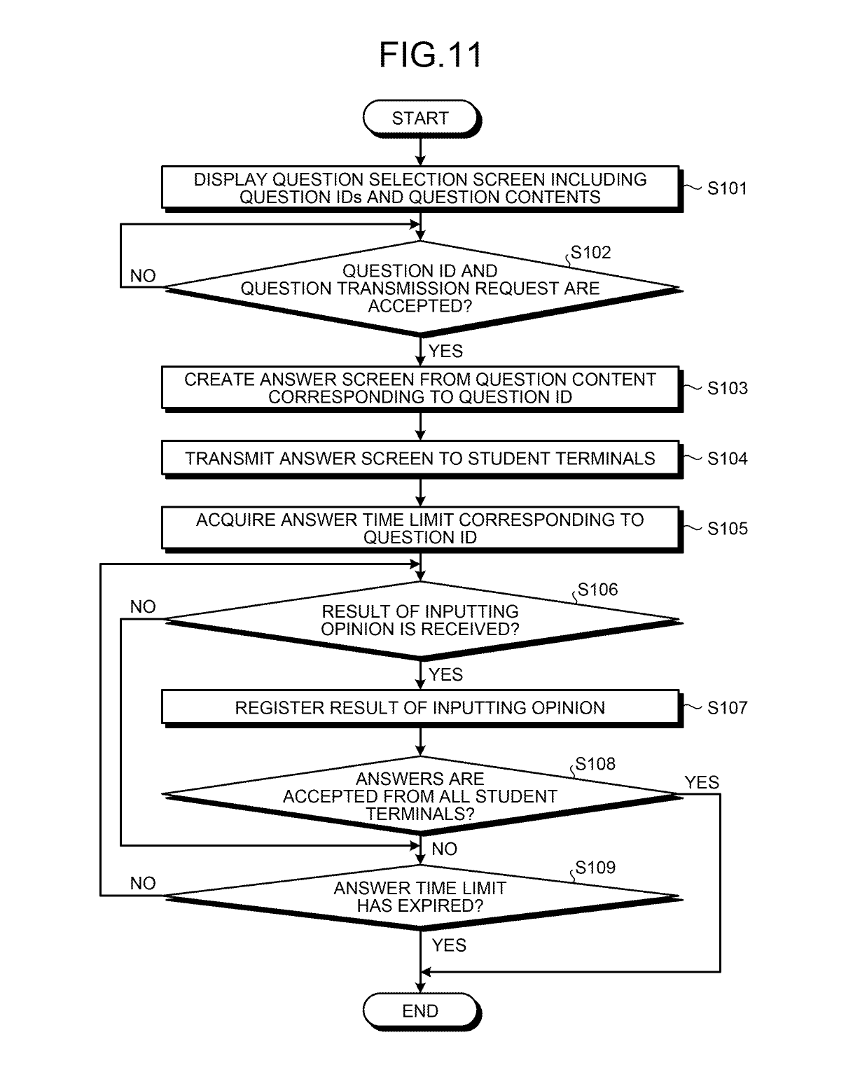

Now a description will be given of the specific examples of the above-described display control with reference to FIGS. 7 to 10. FIG. 7 illustrates one example of the question selection screen. FIG. 8 illustrates one example of the answer screen. FIGS. 9 and 10 illustrate one example of the opinion board. FIG. 9 illustrates the opinion board with scenario indication 220 when the scenario progresses to the discussion point “mutual help,” i.e., when the discussion point “mutual help” is currently selected. FIG. 10 illustrates an opinion board with scenario indication 230 when the scenario progresses to the discussion point “transportation,” i.e., when the discussion point “transportation” is currently selected.

For example, when selection of question distribution is accepted from the menu screen displayed on the touch panel 11, a question selection screen 200 illustrated in FIG. 7 is displayed on the touch panel 11. In one example, the question selection screen 200 is created based on the question data 13b illustrated in FIG. 4. As illustrated in FIG. 7, the question selection screen 200 displays a list of question IDs and question contents included in the question data 13b illustrated in FIG. 4. The question selection screen 200 also displays select buttons to select questions distributed to the student terminals 30 on the left-hand side of the question IDs.

In the state where at least one select button check box is checked, that is, in the state where the check box of the question ID “0002” is checked in the illustrated example, a question transmit button 200A is pressed. In this case, an answer screen for answering to the checked question of the question ID “0002” is distributed to the student terminals 30A to 30C from the teacher terminal 10. When a cancel button 200B is pressed, the menu screen is displayed again without distribution of the checked question to the student terminals 30. Although only the question ID “0002” is selected in this example, a plurality of questions may be selected at a time.

FIG. 8 illustrates an answer screen 210 transmitted from the teacher terminal 10 to the student terminals 30. As illustrated in FIG. 8, the answer screen 210 includes the question content of the question ID “0002” to be answered by the students. The answer screen 210 additionally includes a text box 210C as an opinion column to input an opinion concerning the question, a transmit button 210D for transmitting the answer to the teacher terminal 10, and an opinion clear button 210E for clearing the opinion. With placement of these GUI components, the students can give their opinions such as their arguments and/or ideas concerning the question by inputting character strings in the text box 210C serving as an opinion column. Thus, when the transmit button 210D is pressed in a state where character strings are input as a text in the text box 210C serving as an opinion column, the character strings input in the text box are sent back as an answer to the teacher terminal 10 from the student terminals 30. When the opinion clear button 210E is pressed, the students can clear the pros and cons and their opinions input so far, and can restart input from the beginning.

When the answers to the question are collected from the student terminals 30 in this manner, the opinion board with scenario indication illustrated in FIG. 9 is displayed on the teacher terminal 10 used by the teacher, among the touch panels 11 and the electronic blackboard 20. The opinion board with scenario indication 220 illustrated in FIG. 9 displays a list of the answers of each student with respect to the question of the question ID “0002” displayed in the form of a matrix based on the opinion display area coordinates included in the answer data 13d illustrated in FIG. 6. As illustrated in FIG. 9, the opinion board with scenario indication 220 includes opinion display areas of students displayed in two rows and four columns, each of the areas being 30 dots long and 40 dots wide. More specifically, the opinions of Tanaka, Yamada, Suzuki, and Yamamoto are displayed in order from the upper left to the upper right in the upper row of the opinion board 220. At the same time, the opinions of Kuroda, Honda, Sato, and Asai are displayed in order from the lower left to the lower right in the lower row of the opinion board 220. The electronic blackboard 20 displays the content same as the content of the opinion board with scenario indication 220 except that a scenario indication 300 is hidden on the electronic blackboard 20.

Here, in the opinion board with scenario indication 220, all the opinion display areas are not uniformly displayed. Among a series of discussion points included in the scenario, the discussion point currently selected is displayed in a mode different from a mode of other discussion points. More specifically, the opinion board with scenario indication 220 illustrated in FIG. 9 includes a scenario indication 300 that indicates the progress sequence of a series of discussion points that progress along the sequence of “mutual help,” “transportation,” “acceptance,” and “radioactivity.” Among four discussion points SC1-1 to SC1-4 included in this scenario indication 300, the discussion point SC1-1 “mutual help” corresponding to the progress degree of the scenario is highlighted. More specifically, the discussion point SC1-1 “mutual help” is displayed in white, while other discussion points SC1-2 to SC1-4 “transportation,” “acceptance,” and “radioactivity” are displayed in gray. Such highlighting enables the teacher to visually confirm the progress sequence and/or the progress degree of the scenario, so that the teacher can easily schedule the time allocated to the discussion of each discussion point. As a result, it becomes possible to prevent the lesson time from becoming too long or too short, so that the progress of the lesson can be supported. Moreover, since the breakdown of the number of answers is displayed for each discussion point, the teacher can grasp the deviation of the opinions of the students.

Furthermore, in the opinion board with scenario indication 220 illustrated in FIG. 9, the answers classified into the discussion point “mutual help” corresponding to the progress degree of the scenario are highlighted among each of the opinion display areas. More specifically, while the answers of Tanaka and Yamada, which are classified into the discussion point “mutual help,” are displayed in white, the answers of Suzuki, Yamamoto, Kuroda, Honda, Sato, and Asai, which are classified into other discussion points “transportation,” “acceptance,” and “radioactivity,” are displayed in gray. Such highlighting enables the teacher to grasp the fact that the answers of Tanaka and Yamada are high in correlation with the discussion point “mutual help” before the discussion concerning the discussion point is taken place. This makes it possible to guide the teacher to take up the answers of Tanaka or Yamada in the discussion concerning the discussion point “mutual help,” so that the materials, which can promote the progress of the discussion in the collaborative education setting, can be presented. As a result, the progress of the lesson can be supported.

In addition, the opinion board with scenario indication 220 illustrated in FIG. 9 displays a mark “next representative” which enables the teacher to confirm the answer of Suzuki as a representative opinion among the answers classified into the discussion point “transportation,” which is scheduled to be discussed at the time when the scenario progresses to the subsequent discussion point, among the answers in each opinion display area. Accordingly, after the discussion concerning the discussion point in progress is ended, the teacher can be guided to take up the answer of Suzuki for progress of the discussion. As a result, the procedures for progressing the discussion can be presented in the collaborative education setting. As a result, the progress of the lesson can be supported.

Then, when four-minutes time allocated to the discussion point “mutual help” expires and the scenario progresses to the discussion point “transportation,” the opinion board with scenario indication 230 illustrated in FIG. 10 is displayed. According to this opinion board with scenario indication 230, a highlighted scenario indication 310 enables the teacher to visually confirm that the scenario progresses to the second discussion point SC1-2. The highlighted opinion display area can further guide the teacher to take up the answer of Suzuki for the discussion concerning the discussion point “transportation.” In addition, display of the representative opinion on the subsequent discussion point can guide the teacher to take up the answer of Yamamoto for progressing the discussion after the discussion concerning the discussion point in progress is ended. Thus, whenever the discussion point, which is a checkpoint of the scenario, is changed, display of the opinion board, the scenario indication, and the representative opinion of the subsequent discussion point are updated. As a result, the lesson can be supported without an interval between each discussion point discussed in the scenario.

On the opinion board 220 or the opinion board 230, one opinion can individually be selected by touching each of the opinions of eight students with a touch pen or fingers. When an end button 220A provided on the lower right side of the opinion board 220 or the opinion board 230 is pressed, the collaborative education with respect to the question is ended, and the screen is returned to the menu screen.

Process Flow

A description will now be given of the process flow of the teacher terminal 10 according to this embodiment. Here, the teacher terminal 10 executes the process including (1) a lesson support process, (2) a classification process, and (3) a display control process.

(1) Lesson Support Process

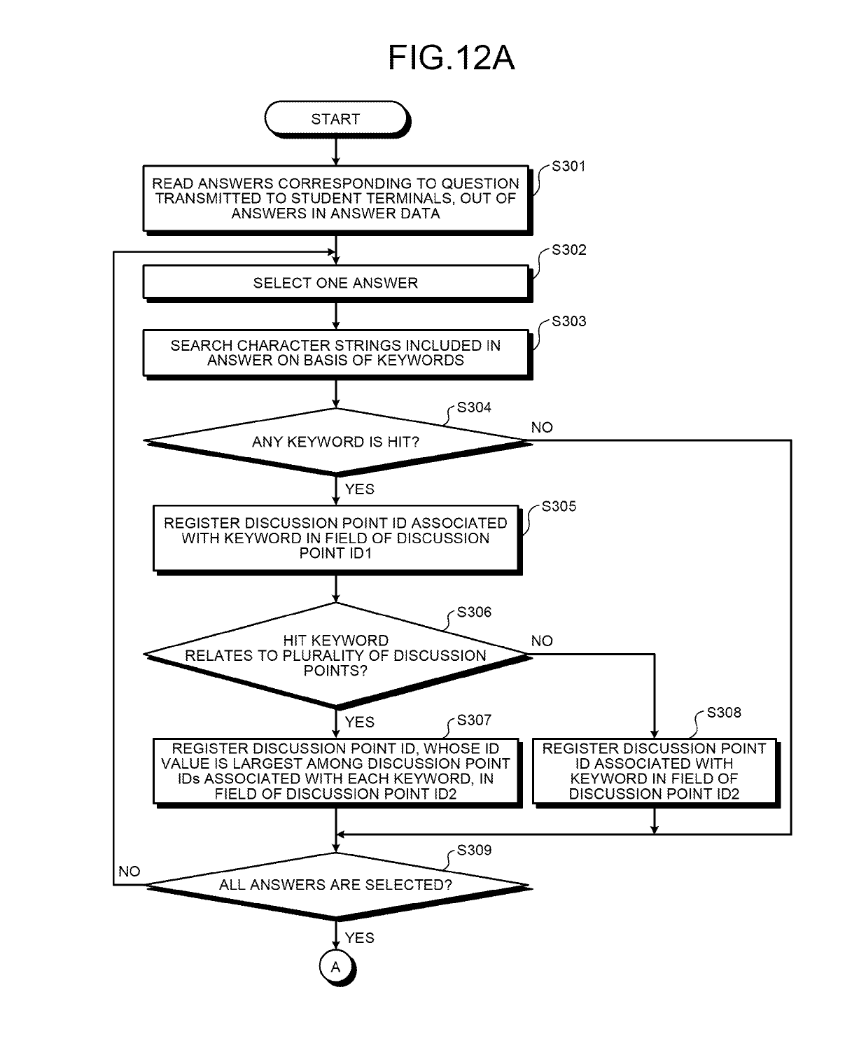

FIG. 11 is a flow chart illustrating procedures of the lesson support process according to the first embodiment. In one example, this process is executed when selection of question distribution is accepted from the menu screen displayed on the touch panel 11.

As illustrated in FIG. 11, the acceptance unit 15a displays on the touch panel 11, the question selection screen including question IDs to be selected and the question transmit button to request distribution of the question (step S101).

When the question transmit button is pressed after the question ID is selected on the question selection screen (Yes in step S102), the acceptance unit 15a executes the following process. That is, the acceptance unit 15a creates an answer screen including a question content corresponding to the question ID whose selection has been accepted in the question selection screen, among the question contents included in the question data 13b (step S103). Next, the acceptance unit 15a transmits the answer screen created in step S103 to the student terminals 30 (step S104).

The acceptance unit 15a also acquires an answer time limit associated with the question ID whose selection has been accepted through the question selection screen, out of the answer time limits included in the question data 13b (step S105).

Then, when an answer, i.e., an opinion concerning the question, which is input in the answer screen, is accepted from a student terminal 30 (Yes in step S106), the acceptance unit 15a executes the following process. That is, the acceptance unit 15a registers the answer in the record of the student ID corresponding to the student terminal 30 which accepted the answer, among the records included in the answer data 13d (step S107). The acceptance unit 15a then determines whether or not the answers are accepted from all the student terminals 30 (step S108). When the answers are accepted from all the student terminals 30 (Yes in step S108), the process is ended without any further processing.

On the contrary, when an answer is not received from the student terminal 30, or when the answers are not accepted from all the student terminals 30 (No in step S106 or No in step S108), the acceptance unit 15a executes the following process. That is, the acceptance unit 15a determines whether or not the answer time limit has expired (step S109).

Then, the acceptance unit 15a repeatedly executes the process in steps S106 to S108 until the answer time limit expires (No in step S109). Then, once the answer time limit expires (Yes in step S109), the acceptance unit 15a ends the process.

(2) Classification Process

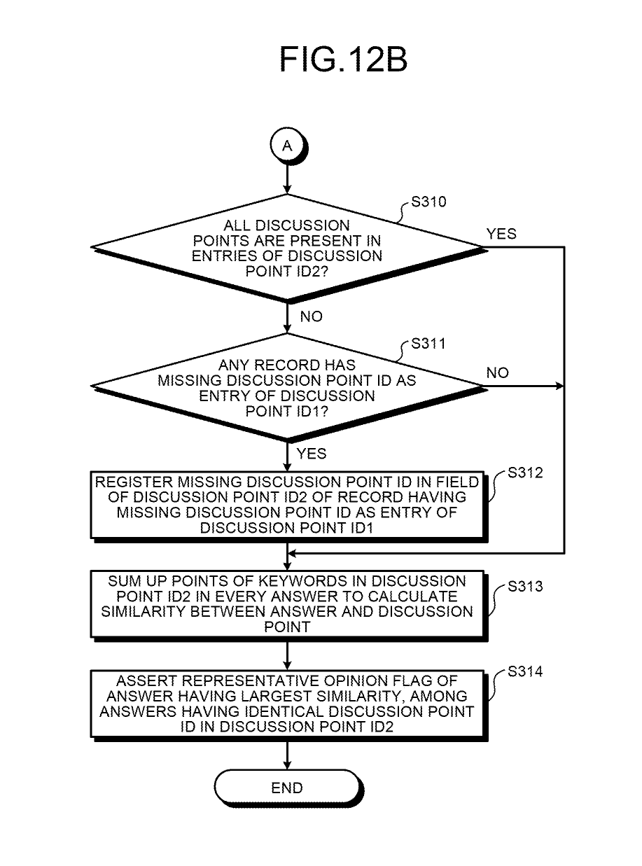

FIGS. 12A and 12B are a flow chart illustrating procedures of the classification process according to the first embodiment. In one example, this classification process is started after the end of the process in the flow chart illustrated in FIG. 11, that is, when the answers are accepted from all the student terminals 30, or the answer time limit expires.

As illustrated in FIGS. 12A and 12B, the classification unit 15b reads the answers corresponding to the question ID of the question transmitted to the student terminals 30, among the answers in the answer data 13d stored in the storage unit 13 (step S301). The classification unit 15b then selects one of the answers read in step S301 (step S302).

In this state, the classification unit 15b searches for the character strings included in the answer selected in step S302 by using keywords associated with the question ID of the question transmitted to the student terminal 30, among the keywords included in the scenario data 13c (step S303).

In this case, when any keywords are hit (Yes in step S304), the classification unit 15b registers a discussion point ID associated with the hit keyword in the field of the discussion point ID1 of the record including an entry of the answer selected in step S302, among the records in the answer data 13d (step S305). When no keyword is hit (No in step S304), the process in steps S305 to S308 is skipped, and the process shifts to step S309.

Here, when the hit keyword relates to a plurality of discussion points (Yes in step S306), the classification unit 15b executes the following process. That is, in the field of the discussion point ID2 of the record including an entry of the answer selected in step S302, among the answers in the answer data 13d, the classification unit 15b registers a discussion point ID whose ID value (discussion point ID registered in the field of the discussion point ID1) is largest among the discussion point IDs associated with each hit keyword (step S307).

Contrary to this, when the hit keyword does not relate to a plurality of discussion points (No in step S306), the classification unit 15b executes the following process. That is, in the field of the discussion point ID2 having an entry of the answer selected in step S302, among the answers in the answer data 13d, the classification unit 15b registers the discussion point ID (the discussion point ID registered in the field of the discussion point ID1) associated with the hit keyword (step S308).

The classification unit 15b repeatedly executes the process in steps S302 to S308 until all the answers read in step S301 are selected (No in step S309).

Then, once all the answers read in step S301 are selected (yes in step S309), the classification unit 15b executes the following determination. That is, the classification unit 15b determines whether or not the discussion point IDs concerning all the discussion points are present in the entries of the discussion point ID2 in the records corresponding to the question ID transmitted to the student terminals 30, among the records in the answer data 13d (step S310).

In this case, when the discussion point IDs concerning all the discussion points are not present (No in step S310), the classification unit 15b further determines whether or not any record includes an absent (missing) discussion point ID as an entry of the discussion point ID1 (step S311).

When a record includes the discussion point ID of the missing discussion point as an entry of the discussion point ID1 (Yes in step S311), the classification unit 15b registers the missing discussion point ID in the field of the discussion point ID2 of this record (step S312). When the discussion point IDs concerning all the discussion points are present, or no record has the discussion point ID concerning the missing discussion point as an entry of the discussion point ID1 (Yes in step S310 or No in step S311), the process shifts to the process of step S313.

Then, for each of the records corresponding to the question ID transmitted to the student terminals 30, among the records in the answer data 13d, the classification unit 15b sums up the points of the keywords included in the character strings of the answer, among the keywords associated with the entries of the discussion point ID2, to calculate the similarity between the answer and each discussion point (step S313).

In this state, the classification unit 15b asserts the representative opinion flag of the answer whose point is largest among the answers having an identical discussion point ID in the discussion point ID2, that is, the classification unit 15b sets the representative opinion flag of the answer to “1” (step S314), and ends the process.

(3) Display Control Process

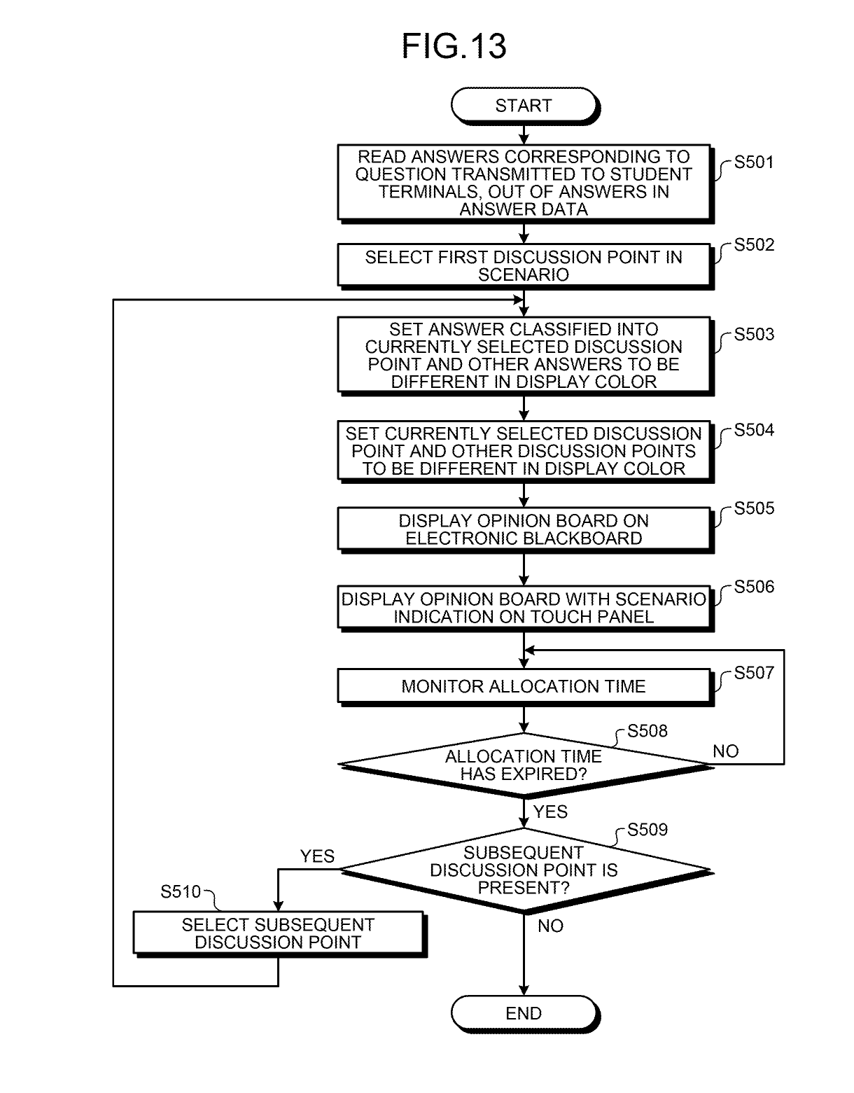

FIG. 13 is a flow chart illustrating procedures of the display control process according to the first embodiment. This process is executed, when the answers are accepted from all the student terminals 30 or the answer time limit expires. More preferably, the process is executed after the classification process illustrated in FIGS. 12A and 12B is ended.

As illustrated in FIG. 13, the display control unit 15d reads the answers corresponding to the question ID transmitted to the student terminals 30, among the answers in the answer data 13d stored in the storage unit 13 (step S501).

Next, the selection unit 15c selects a first discussion point ID out of a series of discussion point IDs included in a scenario corresponding to the question ID transmitted to the student terminals, among the scenarios in the scenario data 13c stored in the storage unit 13. In other words, the selection unit 15c selects a first discussion point in the progress sequence (step S502).

The display control unit 15d then sets an answer to be displayed in white, the answer having the discussion point ID selected in step S502 as an entry of the discussion point ID2, among the answers read in step S501. The display control unit 15d also sets an answer to be displayed in gray, the answer not having the discussion point ID currently selected by the selection unit 15c as an entry of the discussion point ID2 (step S503).

Furthermore, the display control unit 15d sets the discussion point selected in step S502 to be displayed in white, among a series of discussion points constituting the progress sequence, while setting other discussion points to be displayed in gray (step S504).

In this state, the display control unit 15d places the opinion display areas of each answer in a matrix form based on opinion display area coordinates. The display control unit 15d also displays on the electronic blackboard 20 a list of the answers with use of the opinion board by painting out the opinion display areas of each answer in accordance with the display colors set in step S503 (step S505).

The display control unit 15d further displays on the touch panel 11 a scenario indication formed by painting out a series of discussion points that constitute the progress sequence, in accordance with the display colors set in step S504, the scenario indication being included in the opinion board of step S505 (step S506).

Then, the selection unit 15c monitors the allocation time corresponding to the discussion point ID selected in step S502 (step S507). When the allocation time expires (Yes in step S508), the selection unit 15c determines whether or not a series of discussion point IDs include a discussion point ID subsequent to the discussion point ID selected in step S502 (step S509).

In this case, when the subsequent discussion point ID is present (Yes in step S509), the selection unit 15c selects the subsequent discussion point ID (step S510). By using the discussion point ID selected in step S510 instead of the discussion point ID selected in step S502, the process in steps S503 to S508 is repeated.

Then, when the allocation time expires and the subsequent discussion point ID is not present (Yes in step S508 and No in step S509), the process is ended.

One Aspect of Effect

As described in the foregoing, the teacher terminal 10 according to this embodiment highlights a discussion point in progress, included in a scenario that defines the progress sequence of a plurality of discussion points concerning the question, whenever the scenario progresses. The teacher terminal 10 also highlights the answers concerning the discussion point in progress, among the answers to the question displayed as a list. Therefore, in the teacher terminal 10 according to this embodiment, the progress of the lesson can be supported.

### [b] Second Embodiment

While the embodiment of the apparatus in the present invention has been described in the foregoing, the present invention may be performed in various modes different from the embodiment described above. Accordingly, in the following, another embodiment included in the present invention is described.

Shape of Opinion Board

Although a rectangular shape is adopted as the shape of the opinion board in the first embodiment, the shape of the opinion board is not limited thereto. More specifically, other shapes such as polygons, circles, and ellipses may be adopted as the shape of the opinion board.

Method for Dividing Opinion Board

Although the opinions of the students are displayed as a list in a matrix form in the first embodiment, the opinion board may be divided in other forms, and the opinion board may also be unequally divided. Any given dividing methods may be adopted for dividing the opinion board. For example, the students may be divided into groups based on the opinions of the students such as the pros and cons. In this case, the groups are each weighted based on the number of students constituting each group to the number of all the students. Based on the amount of the weight given to each of the groups, the size and/or the shape of the area for displaying the opinion of each group may be changed.

Application Example of Scenario Indication

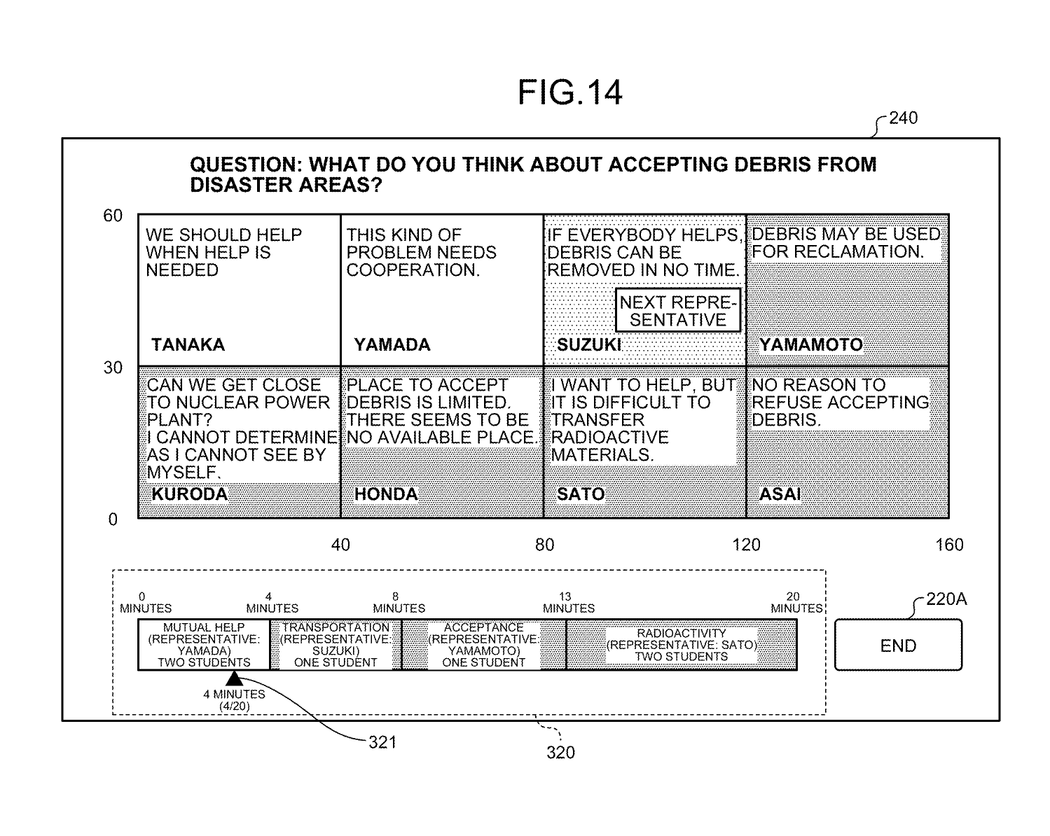

Although the scenario indication illustrated in FIGS. 9 and 10 is illustrated in the above-described first embodiment, the scenario indication is not limited to the illustrated example. More specifically, at least the indication of each discussion point may preferably be displayed, and the progress sequence may more preferably be displayed. FIG. 14 illustrates one example of the opinion board. In the example of an opinion board with scenario indication 240 illustrated in FIG. 14, a lesson timetable having each discussion point as a component may also be displayed as a scenario indication 320. This scenario indication 320 is displayed with the width of time slots set in advance, the width of time slots being formed by proportionally dividing the entire lesson time into time durations allocated to each discussion point. When a slider 321 is displayed on this timetable, the progress degree of the lesson can be grasped in a more intuitive way. As a result, the remaining time of the lesson can be used more effectively.

Other Implementations

In the aforementioned first embodiment, between the teacher terminal 10 and the student terminals 30, the teacher terminal 10 is made to function as a server apparatus while the student terminals 30 are made to function as a client terminal. However, the physical configuration of the lesson support system 1 is not limited to the configuration disclosed. For example, the lesson support system may be implemented as a client/server system further including a server apparatus that incorporates both the teacher terminal 10 and the student terminals 30 as client terminals. In this case, the server apparatus may implement each function in the control unit 15 of the teacher terminal 10. For example, the server apparatus may be implemented as a Web server, which provides the above-described collaborative education support service, or may be implemented as a cloud, which provides collaborative education support service by outsourcing. In that case, the processes illustrated in FIGS. 11 to 13 may each be executed by the server apparatus. The server apparatus may acquire command operation information accepted through the touch panel 11 as an input, and may obtain various screens as a result of processing the information. In this case, the obtained various screens may be displayed on the touch panel 11 and the electronic blackboard 20.

Display Control Program

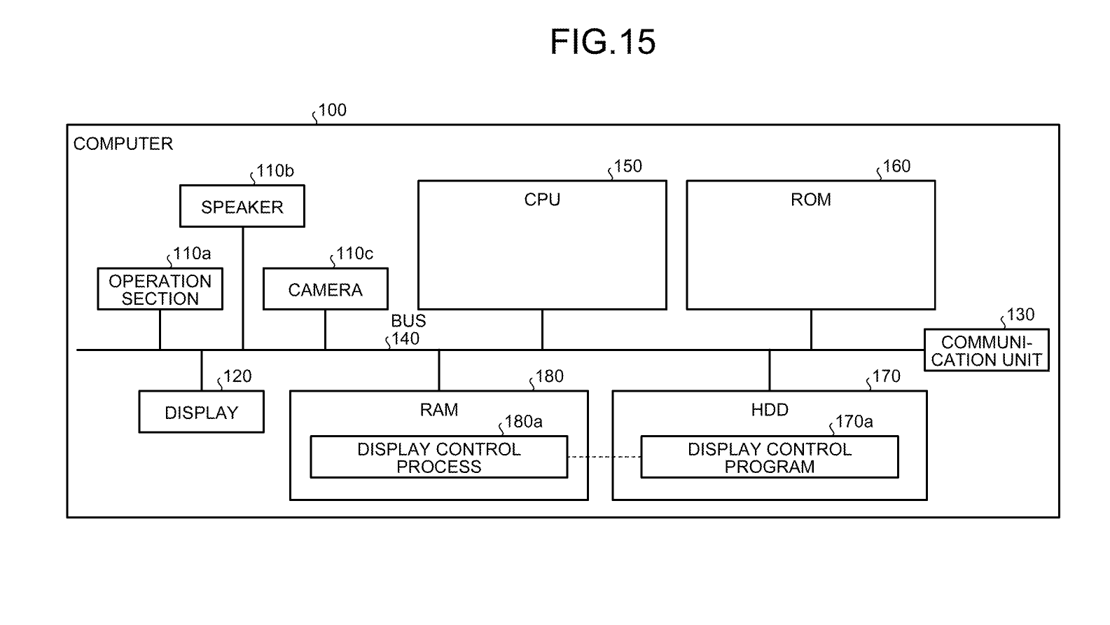

Various processes described in the above-described embodiment can be implemented by causing a computer, such as a personal computer and a workstation, to execute programs prepared in advance. Accordingly, one example of the computer that executes a display control program having the same function as in the above-described embodiment will be described below with reference to FIG. 15.

FIG. 15 is an explanatory view illustrating one example of the computer that executes the display control program according to the first and second embodiments. As illustrated in FIG. 15, a computer 100 includes an operation section 110a, a speaker 110b, a camera 110c, a display 120, and a communication unit 130. The computer 100 further includes a CPU 150, a ROM 160, a HDD 170, and a RAM 180. These units 110 to 180 are each connected through a bus 140.

As illustrated in FIG. 15, a display control program 170a, which exhibits the same functions as the acceptance unit 15a, the classification unit 15b, the selection unit 15c, and the display control unit 15d described in the above-described first embodiment, is preinstalled in the HDD 170. Component members of the display control program 170a may properly be integrated or separated as with the case of each of the component members including the acceptance unit 15a, the classification unit 15b, the selection unit 15c, and the display control unit 15d illustrated in FIG. 2. More specifically, some data stored in the HDD 170 may be stored in other storages. Only the data used for the process of the embodiment may be stored in the HDD 170.

The CPU 150 reads the display control program 170a from the HDD 170, and expands the program in the RAM 180. As a consequence, as illustrated in FIG. 15, the display control program 170a functions as a display control process 180a. The display control process 180a expands various data read from the HDD 170 in an area that is allocated to the display control process 180a and is disposed on the RAM 180. The display control process 180a then executes various processes based on this expanded various data. The display control process 180a includes processes executed in the acceptance unit 15a, the classification unit 15b, the selection unit 15c, and the display control unit 15d illustrated in FIG. 2, that is, the processes illustrated in FIGS. 11 to 13, for example. Some of the processing units virtually implemented on the CPU 150 may be omitted. Only the processing units used for the process may virtually be implemented.

The aforementioned display control program 170a may be obtained not by pre-installation in the HDD 170 and/or the ROM 160. For example, each program may be stored in “portable physical media” inserted into the computer 100, such as so-called FDs or flexible disks, CD-ROMs, DVD disks, magneto-optical disks, and IC cards. The computer 100 may acquire each of the programs from these portable physical media. The programs may be stored in other computers or server apparatuses, which are connected to the computer 100 through public lines, the Internet, LANs, and WANs. The computer 100 may acquire each of the programs from these apparatuses and execute the acquired programs.

The progress of the lesson can be supported.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recoding medium storing a display control program that causes a computer to execute a process comprising:
receiving specification of a question;
referring to scenario data including a scenario in association with each question, the scenario including a plurality of discussion points concerning the question and a sequence of progressing each of the discussion points in a lesson of the question, and selecting one discussion point, out of the plurality of discussion points, in accordance with the sequence of the scenario corresponding to the question; and
displaying, whenever the one discussion point is selected, the one discussion point in a mode different from a mode of other discussion points in display of the scenario, while referring to answer data including answers to each question, and displaying an answer to the one discussion point in a mode different from a mode of other answers in display of a list of answers with respect to the question.

2. The non-transitory computer-readable recoding medium according to claim 1, wherein
the process further includes:
referring to keyword data including keywords concerning each discussion point in association with the each discussion point, and searching for a character string of an answer included in the answer data based on a keyword included in the keyword data; and
classifying the answer into the discussion point associated with the keyword, when a search result is obtained as a result of keyword search, wherein
the displaying includes displaying the answer classified into the one discussion point in a mode different from a mode of other answers in display of the list of the answers.

3. The non-transitory computer-readable recoding medium according to claim 1, wherein
the displaying includes including display of one answer, out of answers corresponding to a subsequent discussion point posterior to the one discussion point in the sequence, in the display of the scenario or in the display of the list of the answers.

4. The non-transitory computer-readable recoding medium according to claim 1, wherein
the displaying includes including display of a breakdown of number of answers for each of the discussion points in the display of the scenario.

5. A display control method comprising:
accepting specification of a question, by a processor;
referring to scenario data including a scenario in association with each question, the scenario including a plurality of discussion points concerning the question and a sequence of progressing each of the discussion points in a lesson of the question, and selecting one discussion point, out of the plurality of discussion points, in accordance with the sequence of the scenario corresponding to the question, by the processor; and
displaying, whenever the one discussion point is selected, the one discussion point in a mode different from a mode of other discussion points in display of the scenario, while referring to answer data including answers to each question, and displaying an answer to the one discussion point in a mode different from a mode of other answers in display of a list of answers with respect to the question, by the processor.

6. A display control apparatus comprising:
a processor configured to execute a process including:
accepting specification of a question;
referring to scenario data including a scenario in association with each question, the scenario including a plurality of discussion points concerning the question and a sequence of progressing each of the discussion points in a lesson of the question, and selecting one discussion point, out of the plurality of discussion points, in accordance with the sequence of the scenario corresponding to the question; and
displaying, whenever the one discussion point is selected, the one discussion point in a mode different from a mode of other discussion points in display of the scenario, while referring to answer data including answers to each question, and displaying an answer to the one discussion point in a mode different from a mode of other answers in display of a list of answers with respect to the question.
